(19) United States
(12) Patent Application Publication
(10) Pub. No.: US 2026/0368757 A1
(43) Pub. Date: Nov. 19, 2026

(54) COUNTERFEIT MANAGEMENT DEVICE AND COUNTERFEIT MANAGEMENT METHOD USING THE SAME

(71) Applicant: NBST Co., Ltd., Pyeongtaek-si (KR)

(72) Inventor: In Suk CHO, Seoul (KR)

(21) Appl. No.: 19/443,705

(22) Filed: Jan. 8, 2026

(30) Foreign Application Priority Data
Jan. 15, 2025 (KR) 10-2025-0005956

(51) Int. Cl. G06Q 30/018

(52) U.S. Cl. CPC G06Q 30/0185

(57) ABSTRACT

Provided are a counterfeit management device capable of accurately determining whether a product is counterfeit using a combination of a visible mark and an invisible mark, and a counterfeit management method using the same. A counterfeit management device according to an aspect of the present invention is a counterfeit management device for determining whether a product is counterfeit by recognizing a counterfeit prevention means provided on the product, and includes an administrator terminal including a processor configured to identify a first mark which is an invisible mark and provided on the product, and a user server used by a user and configured to identify a second mark which is a visible mark and provided on the product, wherein the processor scans and matches the first mark and the second mark to determine whether the product is counterfeit.

### CROSS-REFERENCE TO RELATED APPLICATION

This application claims priority to and the benefit of Korean Patent Application No. 10-2025-0005956, filed on Jan. 15, 2025, the disclosure of which is incorporated herein by reference in its entirety.

### BACKGROUND

### 1. Field of the Invention

The present invention relates to a counterfeit management device and a counterfeit management method using the same, and more particularly, to a counterfeit management device capable of accurately determining whether a product is counterfeit and a counterfeit management method using the same.

### 2. Discussion of Related Art

Various technologies are being proposed to prevent counterfeiting and tampering of expensive goods or products requiring authenticity. Conventionally, technologies using micropatterns, braille, holograms, radio-frequency identifications (RFIDs), etc., have been mainly used to prevent counterfeiting and tampering of products. However, these conventional technologies have limitations in that it is not easy for general users to detect counterfeiting and alteration of products or have a problem of high costs to manufacture counterfeiting and tampering prevention means.

In order to fundamentally solve the problems of the conventional counterfeiting and tampering prevention means described above, various methods have been proposed, a method using a color nanoscale composite such as a photonic crystal among various methods has been proposed. A photonic crystal is a material or crystal that has the property of reflecting only a specific wavelength of incident light and sending the remaining wavelengths of light, thereby exhibiting a color corresponding to that wavelength, and representative examples of the photonic crystal include butterfly wings, beetle shells, etc. Although these materials do not contain pigments, they may produce unique colors because they contain a unique photonic crystal structure.

Despite various methods of preventing counterfeiting and tampering, such as photonic crystals, counterfeiting and tampering may occur. In this case, technologies may be required to estimate or identify information related to counterfeiting, such as the number of instances of counterfeiting and tampering, who committed them, and where they occurred.

### SUMMARY OF THE INVENTION

The present invention is directed to providing a counterfeit management device capable of accurately determining whether a product is counterfeit using a combination of a visible mark and an invisible mark, and a counterfeit management method using the same.

However, objects of the present invention are not limited to the above-described object and other objects that are not described may be clearly understood by those skilled in the art from the following descriptions.

According to an aspect of the present invention, there is provided a counterfeit management device for determining whether a product is counterfeit by recognizing a counterfeit prevention means provided on the product, which includes an administrator terminal including a processor configured to identify a first mark which is an invisible mark and provided on the product, and a user server used by a user and configured to identify a second mark which is a visible mark and provided on the product, wherein the processor scans and matches the first mark and the second mark to determine whether the product is counterfeit.

Both the first mark and the second mark may be placed on one surface of the product and may be placed so that at least portions thereof overlaps.

The first mark may be placed on a wrapper of the product.

The first mark may be provided in an area of the product that indicates important information of the product, and the important information of the product may include distribution network information of the product, composition information of the product, and expiration date information of the product.

A size of the first mark on the product may be determined based on weighting factors assigned to each of the distribution network information of the product, the composition information of the product, and the expiration date information of the product, according to a type of the product.

The first mark may be provided as a plurality of first marks, and the first mark may include a first sub-mark, which is provided in an area of the product that includes manufacturer information of the product, a second sub-mark, which is provided in an area of the product that includes distributor information of the product, and a third sub-mark, which is provided in an area of the product that includes government agency information related to the product.

The processor may provide information on the product determined as counterfeit to the user server.

According to another aspect of the present invention, there is provided a counterfeit management method using a counterfeit management device for determining whether a product is counterfeit by recognizing a counterfeit prevention means provided on the product, which includes identifying a first mark which is an invisible mark and provided on the product, identifying a second mark which is a visible mark and provided on the product, and scanning and matching the first mark and the second mark to determine whether the product is counterfeit.

### BRIEF DESCRIPTION OF THE DRAWINGS

The following drawings attached to this specification illustrate exemplary embodiments of the present invention and, together with the detailed description of the present invention which will be described below, serve to further understand the technical idea of the present invention, and therefore, the present invention should not be interpreted as being limited to matters described in such drawings.

The above and other objects, features and advantages of the present invention will become more apparent to those of ordinary skill in the art by describing exemplary embodiments thereof in detail with reference to the accompanying drawings, in which:

FIG. 1 is a diagram illustrating a counterfeit management device according to an embodiment of the present invention;

FIGS. 2 to 4 are diagrams illustrating examples of a counterfeit prevention means on a product;

FIG. 5 is a diagram illustrating an example of a counterfeit management method using the counterfeit management device of FIG. 1; and

FIG. 6 is a flowchart illustrating a counterfeit management method according to an embodiment of the present invention.

### DETAILED DESCRIPTION OF EXEMPLARY EMBODIMENTS

Hereinafter, exemplary embodiments of the present invention will be described in detail with reference to the accompanying drawings. Prior to this, terms and words used in following description and drawings should not be interpreted as being limited to commonly used meanings or meanings in dictionaries and should be interpreted with meanings and concepts which are consistent with the technological scope of the present invention based on the principle that the inventors have appropriately defined concepts of terms in order to describe the present invention in the best way.

Therefore, since embodiments described in this specification and configurations illustrated in the drawings are only exemplary embodiments and do not represent the overall technological scope of the present invention, it is understood that the present invention covers various equivalents, modifications, and substitutions at the time of filing of this application.

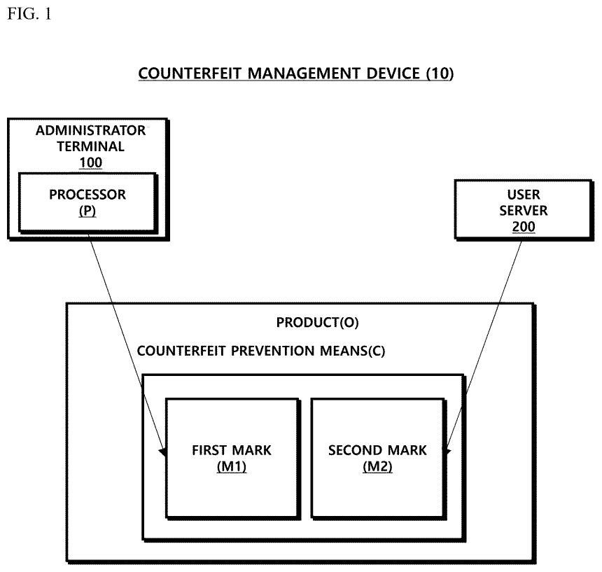

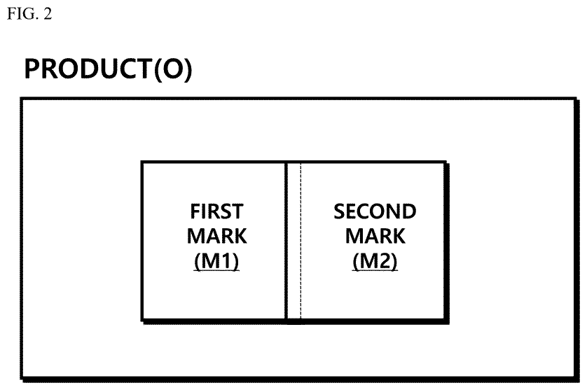

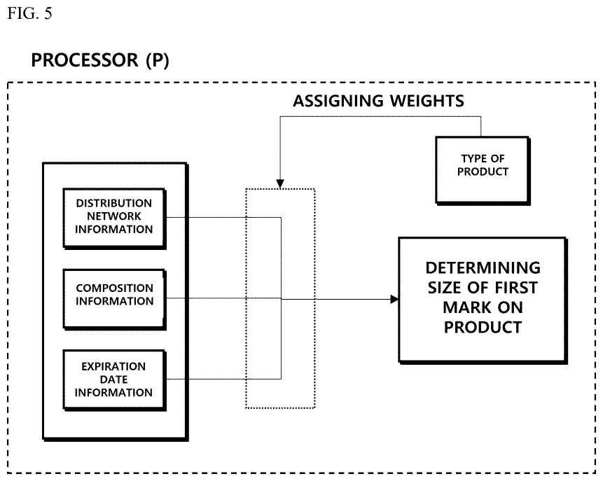

FIG. 1 is a diagram illustrating a counterfeit management device 10 according to an embodiment of the present invention, FIGS. 2 to 4 are diagrams illustrating examples of a counterfeit prevention means C on a product O, and FIG. 5 is a diagram illustrating an example of a counterfeit management method using the counterfeit management device of FIG. 1.

Referring to FIGS. 1 to 5, the counterfeit management device 10 according to the embodiment of the present invention may determine whether the product O is counterfeit by recognizing the counterfeit prevention means C provided on the product O. The counterfeit management device 10 may include an administrator terminal 100 and a user server 200. Further, the product O may correspond to one of various objects, such as daily necessities (e.g., cosmetic containers and the like), parts of electronic products, etc. In addition, the counterfeit prevention means C may include a first mark M1 and a second mark M2.

The administrator terminal 100 may include a processor P that is configured to identify the first mark M1 which is an invisible mark and provided on the product O. The administrator terminal 100 may be used by an administrator. In this case, the administrator terminal 100 may be operated in a mobile application manner. As an example, the first mark M1 may be a mark that is identifiable in a manner that is invisible to the human eyes, may include ultraviolet (UV) ink, an infrared (IR) marker, a radio-frequency identification (RFID) tag, a material that can be recognized through a chemical reaction, etc., and may be identified through the administrator terminal 100 (e.g., UV light, a laser of a specific wavelength, and a device that detects a signal of a specific wavelength), which is a special device. Further, the administrator terminal 100 may be a mobile device used by the administrator. In addition, the administrator terminal 100 may further include a memory (not illustrated) and may be configured to store instructions for a computer program or application that implements a method of identifying the first mark MI, and the processor P may execute the instructions stored in the memory to execute the program or application. For example, the memory may be implemented as a non-volatile memory such as a read-only memory (ROM), a programmable ROM (PROM), an erasable programmable ROM (EPROM), an electrically erasable programmable ROM (EEPROM), a flash memory, a phase-change random access memory (PRAM), a magnetoresistive RAM (MRAM), a resistive RAM (RRAM), a ferroelectric RAM (FRAM), etc., or as a volatile memory such as a dynamic random access memory (DRAM), a static random access memory (SRAM), a synchronous dynamic RAM (SDRAM), a PRAM, a RRAM, a FeRAM, etc., and may be implemented in the form of a hard disk drive (HDD), a solid-state drive (SSD), a secure digital (SD) card, a micro-SD card, etc., or a combination thereof. The processor P may be implemented as an array of logic gates, a microprocessor, a central processing unit (CPU), a graphics processing unit (GPU), an application processor (AP), or a combination thereof.

The user server 200 may identify the second mark M2 which is a visible mark and provided on the product O. The user server 200 may be used by a user. In this case, the user server 200 may be operated in a web server manner without installing a separate dedicated application. As an example, the second mark M2 is a generally identifiable visual mark and may include a quick-response (QR) code, a barcode, etc. Further, the user server 200 may be a server device or a computer device.

In this case, the processor P may scan and match the first mark M1 and the second mark M2 to determine whether the product O is counterfeit. In addition the processor P may provide information on the product O determined as counterfeit to the user server 200.

According to this implementation configuration, unlike conventional technologies, it is possible to determine whether the product O is counterfeit using both a visible mark and an invisible mark that is difficult to counterfeit, and thus there is an advantage in that it is possible to more accurately determine whether the product O is counterfeit.

Further, according to the counterfeit management device 10 of the present invention, it is possible to accurately determine whether various products O are counterfeit, and thus there is an advantage in that it is possible to provide convenience and reliability by allowing users (consumers) to easily determine whether the products O are counterfeit.

Referring to FIG. 2, both the first mark M1 and the second mark M2 may be placed on one surface of the product O. In addition, the first mark M1 and the second mark M2 may be placed so that at least portions thereof overlap.

That is, when both the first mark M1 and the second mark M2 are placed on one surface of the product O and are placed so that at least portions thereof overlap, it may be extremely difficult to counterfeit the product O, and even when the product O is counterfeited, it is possible to accurately determine whether the product O is counterfeit because the arrangement of the first mark M1 and the second mark M2 is different from that of a genuine product.

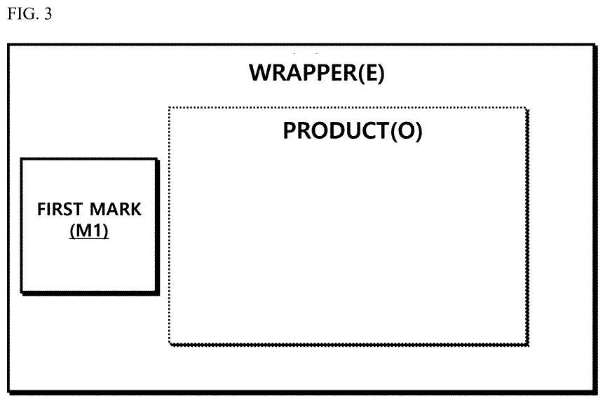

Referring to FIG. 3, the first mark MI may be placed on a wrapper E of the product O. The wrapper E may surround at least a portion of the product O.

Specifically, the first mark M1 is placed on the wrapper E of the product O, and thus it is also possible to prevent an act of distributing the product O by forging only the wrapper E without forging the product O itself and then by changing product information.

In an embodiment, the first mark M1 may be provided in an area of the product O that indicates important information of the product O.

In this case, the important information of the product O may include distribution network information of the product O, composition information of the product O, and expiration date information of the product O.

In an embodiment, the distribution network information of the product O may be recognized as the important information of the product O because counterfeit products may be distributed through an anomalous channel when the product O does not follow the manufacturer's approved distribution network.

Further, the composition information of the product O may be recognized as the important information of the product O because products O with counterfeit compositions may threaten the health of users (consumers), in particular, in the fields of pharmaceuticals, cosmetics, food, etc.

Further, the expiration date information of the product O may be recognized as the important information of the product O because products (e.g., medicines, food, etc.) for which the expiration dates thereof are considered important may lose their effectiveness or become harmful to the human body after the expiration dates.

That is, in the case of the counterfeit management device 10 of the present invention, the first mark M1 which is an invisible mark may be provided in an area that indicates the important information of the product O, and thus it is possible to guide the counterfeiting of important parts of the product O so that it is not easily counterfeited.

Referring to FIG. 5, the size of the first mark M1 in the product O may be determined based on weighting factors assigned to each of the distribution network information of the product O, the composition information of the product O, and the expiration date information of the product O, according to the type of the product O. In this case, the weighting factors may be set by the processor P described above.

That is, in the case of the counterfeit prevention means C, a weight may be set to the important information of the product O according to the type of the product O so that the degree of generation in the product O of the first mark M1 which is an invisible mark may be adjusted.

In an embodiment, when the product O is a cosmetic or a pharmaceutical, in setting the degree of generation in the product O of the first mark MI, a greater weight may be set to the composition information of the product O than to the distribution network information of the product O and the expiration date information of the product O. This is because, when the product O is a cosmetic or a pharmaceutical, the composition information of the product O is considered to be a more important factor than the distribution network information of the product O and the expiration date information of the product O because the health of the users (consumers) may be seriously threatened when the compositions of the product O are counterfeited. In this case, a size of the first mark M1 for the composition information of the product O may be set greater than a size of the first mark MI for the distribution network information of the product O and the expiration date information of the product O.

Further, when the product O is a food, in setting the degree of generation in the product O of the first mark M1, greater weights may be set to the distribution network information of the product O and the expiration date information of the product O than to the composition information of the product O. This is because, when the product O is a food, the possibility of the compositions of the product O being counterfeited is low, but the food may become spoiled due to a problem during the distribution process, and thus the health of users (consumers) may be seriously threatened, and thus the distribution network information of the product O and the expiration date information of the product O are considered to be more important factors than the composition information of the product O. In this case, the size of the first mark M1 for the distribution network information of the product O and the expiration date information of the product O may be set greater than the size of the first mark M1 for the composition information of the product O.

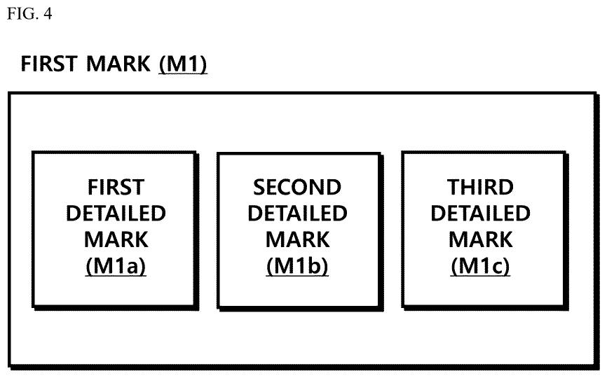

Referring to FIG. 4, the first mark M1 may be provided as a plurality of first marks M1.

Specifically, the first mark M1 may include a first sub-mark M1a, a second sub-mark M1b, and a third sub-mark M1c.

The first sub-mark M1a may be provided in an area of the product O that includes manufacturer information of the product O. In an embodiment, the administrator terminal 100 may identify the first sub-mark M1a to confirm the manufacturer information of the product O and may check whether the manufacturer information of the product O has been counterfeited.

The second sub-mark M1b may be provided in an area of the product O that includes distributor information of the product O. In an embodiment, the administrator terminal 100 may identify the second sub-mark M1b to confirm the distributor information of the product O and may check whether the distributor information of the product O has been counterfeited.

The third sub-mark M1c may be provided in an area of the product O that includes government agency information (e.g., customs service, tax office, etc.) related to the product O. In an embodiment, the administrator terminal 100 may identify the third sub-mark M1c to confirm distributor information of the product O and may check whether the government agency information related to the product O has been counterfeited.

In an embodiment, the sizes of the first sub-mark M1a, the second sub-mark M1b, and the third sub-mark M1c in the first mark M1 may be determined based on weight factors assigned to each of the first sub-mark M1a, the second sub-mark M1b, and the third sub-mark M1c, according to the supplier of the product O. In this case, the weighting factors may be set by the processor P described above.

That is, in the case of the first mark M1, weights may be set to the first sub-mark M1a, the second sub-mark M1b, and the third sub-mark M1c according to the supplier of the product O so that the degree of generation in the first mark M1 of the first sub-mark M1a, the second sub-mark M1b, and the third sub-mark M1c which are invisible marks may be adjusted.

In an embodiment, when the supplier of the product O is a company, in setting the degree of generation in the first mark M1 of the first sub-mark M1a, the second sub-mark M1b, and the third sub-mark M1c, greater weights may be set to the first sub-mark M1a and the second sub-mark M1b than to the third sub-mark M1c. This is because, when the supplier of the product O is a company, the first sub-mark M1a indicating the manufacturer information of the product O or the second sub-mark M1b indicating the distributor information of the product O is considered to be a more important factor than the third sub-mark M1c indicating the government agency information related to the product O. In this case, the sizes of the first sub-mark M1a and the second sub-mark M1b may be set greater than the size of the third sub-mark M1c.

In an embodiment, when the supplier of the product O is a government agency, in setting the degree of generation in the first mark M1 of the first sub-mark M1a, the second sub-mark M1b, and the third sub-mark M1c, a greater weight may be set to the third sub-mark M1c than to the first sub-mark M1a and the second sub-mark M1b. This is because, when the supplier of the product O is a government agency, the third sub-mark M1c indicating the government agency information related to the product O is considered to be a more important factor than the first sub-mark M1a indicating the manufacturer information of the product O or the second sub-mark M1b indicating the distributor information of the product O. In this case, the size of the third sub-mark M1c may be set greater than the sizes of the first sub-mark M1a and the second sub-mark M1b.

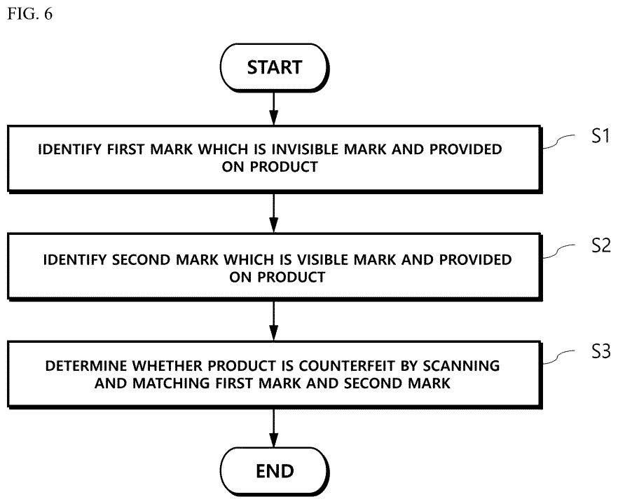

FIG. 6 is a flowchart illustrating a counterfeit management method according to an embodiment of the present invention.

Referring to FIG. 6, the counterfeit management method according to the embodiment of the present invention may include operations S1 to S3 described below.

In operation S1, a first mark M1 which is an invisible mark and provided on a product O may be identified. In this case, operation S1 may be performed by the administrator terminal 100 described above.

In operation S2, a second mark M2 which is a visible mark and provided on the product O may be identified. In this case, operation S2 may be performed by the user server 200 described above.

In operation S3, the first mark M1 and the second mark M2 may be scanned and matched to determine whether the product O is counterfeit. In this case, operation S3 may be performed by the processor P described above.

According to an aspect of the present invention, unlike conventional technologies, it is possible to determine whether a product is counterfeit using both a visible mark and an invisible mark that is difficult to counterfeit, and thus there is an advantage in that it is possible to more accurately determine whether the product is counterfeit.

Further, according to the counterfeit management device of the present invention, it is possible to accurately determine whether various products are counterfeit, and thus there is an advantage in that it is possible to provide convenience and reliability by allowing users (consumers) to easily determine whether the product is counterfeit.

In addition, according to various embodiments of the present invention, various additional effects can be achieved. These various effects of the present invention are described in detail in each embodiment, and descriptions of effects easily understood by those skilled in the art are omitted.

As described above, while the present invention has been described with reference to specific embodiments and drawings, the present invention is not limited thereto. It is clear by those skilled in the art that various modifications and alterations may be made without departing from the spirit and scope of the present invention and equivalents of the appended claims.

Meanwhile, although terms indicating directions such as up, down, left, right, front, and back are used in the present invention, it is obvious to those skilled in the art that these terms are only for the convenience of description and may vary depending on a location of a target object or a location of an observer.

What is claimed is:

1. A counterfeit management device for determining whether a product is counterfeit by recognizing a counterfeit prevention means provided on the product, the counterfeit management device comprising:
an administrator terminal including a processor configured to identify a first mark which is an invisible mark and provided on the product; and
a user server used by a user and configured to identify a second mark which is a visible mark and provided on the product,
wherein the processor scans and matches the first mark and the second mark to determine whether the product is counterfeit.

2. The counterfeit management device of claim 1, wherein both the first mark and the second mark are placed on one surface of the product and are placed so that at least portions thereof overlap.

3. The counterfeit management device of claim 1, wherein the first mark is placed on a wrapper of the product.

4. The counterfeit management device of claim 1, wherein the first mark is provided in an area of the product that indicates important information of the product, and
the important information of the product includes distribution network information of the product, composition information of the product, and expiration date information of the product.

5. The counterfeit management device of claim 4, wherein a size of the first mark on the product is determined based on weighting factors assigned to each of the distribution network information of the product, the composition information of the product, and the expiration date information of the product, according to a type of the product.

6. The counterfeit management device of claim 1, wherein the first mark is provided as a plurality of first marks, and
the first mark includes:
a first sub-mark which is provided in an area of the product that includes manufacturer information of the product;
a second sub-mark which is provided in an area of the product that includes distributor information of the product; and
a third sub-mark which is provided in an area of the product that includes government agency information related to the product.

7. The counterfeit management device of claim 1, wherein the processor provides information on the product determined as counterfeit to the user server.

8. A counterfeit management method using a counterfeit management device for determining whether a product is counterfeit by recognizing a counterfeit prevention means provided on the product, the counterfeit management method comprising:
identifying a first mark which is an invisible mark and provided on the product;
identifying a second mark which is a visible mark and provided on the product; and
scanning and matching the first mark and the second mark to determine whether the product is counterfeit.
